(19) United States
(12) Patent Application Publication
(10) Pub. No.: US 2008/0010807 A1
(43) Pub. Date: Jan. 17, 2008

(54) Multi-Pitch Screw, And Manufacturing Method And Manufacturing Apparatus Of Multi-Pitch Screw

(75) Inventors: Hiroshi Fujii, Aichi (JP); Naoki Sase, Toyama (JP); Kenichi Katayama, Gifu (JP); Yoshinori Moriguchi, Gifu (JP)

Correspondence Address: LUCAS & MERCANTI, LLP, 475 PARK AVENUE SOUTH, 15TH FLOOR, NEW YORK, NY, 10016, US

(73) Assignee: NAGOYA INDUSTRIAL SCIENCE RESEARCH INSTITUTE, AICHI (JP)

(21) Appl. No.: 11/569,368

(22) PCT Filed: Jul. 20, 2005
(86) PCT No.: PCT/JP05/13300

§ 371 Date: Nov. 20, 2006

(30) Foreign Application Priority Data
Aug. 6, 2004 (JP) 2004-230119

(51) Int. Cl. B23P 13/04

(52) U.S. Cl. 29/558; 29/27 R; 411/310

(57) ABSTRACT

The invention presents a method of manufacturing a multi-pitch screw having desired threads and pitches by rolling. A trace of general (even lead angle) spiral screw is formed by even pitch protrusions 610 and 620 of an existing rotating dies 61 and 62, and it is combined with a trace of stair step screw formed by stair step protrusions 632 of a rotating die 63 of uneven lead angle, and multi-pitch screw threads are formed efficiently. Herein, only one rotating die 61 of uneven lead angle is used, and screw threads are not flattened out by stair step protrusions of the plurality of rotating dies of uneven lead angles.

### TECHNICAL FIELD

The invention relates to a multi-pitch screw having a plurality of leads (a multi-pitch screw forming screw threads spirally, with a moderate section of a lead angle and a steep section of a lead angle formed alternately and continuously in one revolution of a spiral form), a manufacturing method of the multi-pitch screw, and an apparatus for manufacturing the same.

### BACKGROUND ART

Various countermeasures have been proposed against loosening of screw for tightening, but nothing has been perfect.

Changing the conventional concept of a screw (a screw having a constant pitch), the inventors have studied and confirmed that the problem can be solved by a new concept of a screw, that is, a screw having a plurality of leads, or a multi-pitch screw having lead portions differing in a pitch formed continuously (see non-patent document 1).

The inventors have also proposed a structure and combination of a bolt and a nut of a multi-pitch screw having a plurality of leads, and their application in a feed screw mechanism in Japanese Patent Application No. 2002-346891.

Hitherto, relating to the multi-pitch screw having a plurality of leads, an intermittent feed device has been known, in which V-grooves sequentially deviated in an axial direction are provided consecutively on the outer circumference of bar member, and engaging pieces to be engaged with the grooves are moved intermittently. Spiral grooves of a screw (a feed shaft) of this device comprise a large groove of a linear deep groove bottom and a small groove of a shallow groove bottom formed alternately and consecutively as in the device shown, for example, in Prior art 1, and when the engaging piece forced elastically in the groove bottom direction slides and contacts with the both opposite sides of one groove, the lead angle is zero, and when sliding and contacting with opposite sides of different grooves, a specified lead angle is produced.

A method of manufacturing the screw (the feed shaft) used in such intermittent feed device includes a known manufacturing method of using a cylindrical cutting tool formed along a circumferential direction parallel to a rotating direction, having multiple (n) blades formed at an equal interval in a circumferential direction, sequentially deviated by 1/n pitch in an axial direction. In this manufacturing method, for example, as shown in the manufacturing method disclosed in Prior art 2, a workpiece formed like a bar and the cutting tool are rotated by 1:1 in the same direction, and V-grooves sequentially deviated in the axial direction contact with the outer circumference of the workpiece, and spiral grooves consecutive in stair steps are processed.

The screw (spiral grooves/threads) having linear grooves formed consecutively in stair steps may be not smooth in motion at changeover positions or may cause noise, and to solve these problems, it is proposed to form the changeover positions in a curve, such as a lead screw disclosed in Prior art 3.

General screws having constant spiral pitches are manufactured in various methods and various apparatuses and they are put into a practical use. For example, a rolling machine is disclosed in Prior art 4, in which a plurality of rotating dies having annular protruding waveform shapes formed on the outer circumference are used, each rolling die is disposed at a specific twist angle to the round bar of the workpiece, and the round bar is moved in the relative rotating and axial directions between rolling dies, so that a method and a apparatus that male threads are processed plastically on the outer circumference of the round bar is publicly known.

Prior art 1: Japanese Utility Model No. 3-43488 Y is incorporated herein by reference.

Prior art 2: JP 63-12724 B is incorporated herein by reference.

Prior art 3: Japanese Utility Model Application Publication No. 62-74475 U is incorporated herein by reference.

Prior art 4: JP 59-37699 B is incorporated herein by reference.

Non-patent document 1: Collected Papers of Japan Society of Mechanical Engineers, Part C, Vol. 62 (No. 597), pp. 1963-1968, “Development of a screw tightening body very less likely to be loosened,” Hiroshi Fujii, et al., 1996 is incorporated herein by reference.

### DISCLOSURE OF THE INVENTION

Problems to be Solved by the Invention

To prevent loosening of a tightening screw, a multi-pitch screw (a bolt member) is extremely effective, but technology for manufacturing it efficiently and economically is not established, and it is far from practical. Similarly, the feed screw mechanism by applying the principle of this multi-pitch screw is also difficult in manufacturing the feed screw (bolt member) and it is very expensive.

The screw (the feed shaft) of the device disclosed in Prior art 1 includes a large groove of a linear deep groove bottom and a small groove of a shallow groove bottom formed alternately and consecutively, and when it is used as a tightening screw (a bolt member), the strength is not enough because of the uneven groove depth. An action as the multi-pitch screw is presented only by sliding combination of engaging pieces elastically forced in a groove bottom direction and grooves, and combination with general female threads (a nut member) is not taken into consideration.

The manufacturing method disclosed in Prior art 2 is intended to process spiral grooves consecutive in stair steps by a cylindrical cutting tool having multiple blades provided on the outer circumference, and there is a problem that the material may be consumed by cutting. The screw (the bolt member) manufactured in this method has the same effects as the screw (feed shaft) of the device in Prior art 1.

The lead screw disclosed in Prior art 3 is curved in the screw (spiral grooves/threads) having linear grooves formed consecutively in stair steps, and is preferred for machining of the feed screw, but its manufacturing method is not disclosed, and it is far from practical.

The rolling machine disclosed in Prior art 4 is designed to process male threads plastically on the outer circumference of round bar, by moving the round bar in a relative rotating and an axial direction between rolling dies, and the rolling process is efficient and the material is not consumed by cutting, and the strength of plastically processed threads is increased. However, if this rolling machine or a method was directly employed, the multi-pitch screw (the bolt member) having desired threads and pitches could not be manufactured.

It is hence an object of the invention to present a multi-pitch screw (a bolt member) having desired threads and pitches manufactured by an efficient rolling process not consuming the material, and a method and an apparatus for manufacturing this multi-pitch screw.

Means for Solving the Problems

In order to achieve the above object, according to claim 1, a manufacturing method of a multi-pitch screw for rolling and processing spiral multi-pitch screw threads on an outer circumference of a shaft-shaped blank material, by a plurality of rotating dies having protrusions of inverted V figure linked annularly or spirally on the outer circumference,

wherein other rotating dies except for one of the plurality of rotating dies are rotating dies for manufacturing a screw of even lead angles, having protrusions provided at even pitches,

the one rotating die is a die for manufacturing a screw of uneven lead angles having protrusions provided in part as stair steps changing in waves in the groove direction, and

multi-pitch screw threads are rolled by the plurality of rotating dies, overlapped between the trace of even lead angle threads formed by protrusions of even pitches on the outer circumference of the shaft-shaped blank material, and the trace of stair step screw threads formed by threads formed by protrusions of even pitches on the outer circumference of the shaft-shaped blank material.

According to claim 2, a manufacturing method of a multi-pitch screw for rolling and processing spiral multi-pitch screw threads on an outer circumference of a shaft-shaped blank material, by a plurality of rotating dies having annular protrusions of inverted V figure linked on the outer circumference,

wherein other rotating dies except for one of the plurality of rotating dies are rotating dies for manufacturing a screw of even lead angles, having protrusions provided at even pitches,

the one rotating die is a die for manufacturing a screw of uneven lead angles having protrusions provided in part as stair steps changing in waves in the groove direction, wider slightly in width and slightly lower in height as compared with the protrusions of even pitch, and provided at even pitch in a remaining portion except for the stair step protrusions,

multi-pitch screw threads are rolled by the plurality of rotating dies, overlapped between the trace of even lead angle threads formed by protrusions of even pitches on the outer circumference of the shaft-shaped blank material, and the trace of stair step screw threads formed by threads formed by protrusions of even pitches on the outer circumference of the shaft-shaped blank material.

According to claim 6,a multi-pitch screw,

wherein the bottom portion between threads is an even lead angle, and

the side wall of screw threads are formed alternately and continuously between a moderate section and a steep section of the lead angle alternating in one revolution of the helical line.

### EFFECTS OF THE INVENTION

In the invention as set forth in claim 1, a trace of a general spiral screw formed by equal pitch protrusions of an existing rotating die, and the trace of the stair step screw formed by stair step protrusions for manufacturing the screw of uneven lead angles are overlapped, and multi-pitch screw threads can be rolled easily and efficiently. Theoretically, it is possible to apply all rotating dies as rotating dies for manufacturing threads of uneven lead angles, but even though precisely processed, there is a processing error between mutual rotating dies for manufacturing the screw of uneven lead angles, the stair step screw threads rolled by stair step protrusions of one rotating die for manufacturing the screw of uneven lead angles may be flattened out by the stair step protrusions of other rotating die for manufacturing the screw of uneven lead angles, and it is practically impossible. By contrast, according to the invention of claim 1, since screw threads are not flattened out by the stair step protrusions of plural rotating dies for manufacture of screw of uneven lead angles, and without using rotating dies for manufacture of screw of uneven lead angles of very high processing precision, multi-pitch screws can be manufactured appropriately by one rotating die for manufacture of screw of uneven lead angles. Further, the rotating dies for manufacture of screw of uneven lead angles are very difficult to manufacture and expensive, but only one rotating die can be used in claim 1, and the multi-pitch screws can be manufactured economically.

In the invention of claim 1, as the rotating die for manufacturing the screw of uneven lead angles, when the one forming annular protrusions on the outer circumference is used, only part of protrusions is used in rolling, and other protrusions are used for feeding of rolled threads, and the rotating die for manufacturing the screw of uneven lead angles is preferred to be partly manufactured in a step-like uneven pitch, and the remaining protrusions are preferred to be manufactured in even pitch. This is because the manufacturing cost is increased when all protrusions are manufactured in stair steps, and it is also effective to prevent flattening of multi-pitch threads formed by part of protrusions by the feeding portion (remaining protrusions).

On the other hand, when using the one forming protrusions linked spirally on the outer circumference as the rotating die for manufacturing the screw of uneven lead angles, the protrusions can be manufactured in stair steps in the overall length.

In the invention as set forth in claim 2, the trace of the general spiral screw formed by equal pitch protrusions of the existing rotating die, and the trace of the stair step screw formed by stair step protrusions of the rotating die for manufacturing the screw of uneven lead angles are overlapped, and multi-pitch screw threads can be rolled easily and efficiently. Since only one rotating die for manufacturing the screw of uneven lead angles is used, screw threads are not flattened out by stair step protrusions of the plurality of rotating dies for manufacture of screw of uneven lead angles. Further, the rotating dies for manufacturing the screw of uneven lead angles are very difficult to manufacture and expensive, but only one rotating die can be used and stair case protrusions are provided only in part in claim 2, and multi-pitch screws can be manufactured at low cost. The rotating die for manufacturing the screw of uneven lead angles is manufactured in stair step protrusions only in part, and the remaining protrusions are in even pitch, and it is effective to prevent flattening of multi-pitch threads formed by the part of stair step protrusions by the feeding portion (the remaining protrusions).

Further in the invention of claim 2, even pitch protrusions of the rotating die for manufacturing the screw of even lead angles are higher than stair step protrusions of the rotating die for manufacturing the screw of uneven lead angles, and narrower in width. Accordingly, the even pitch protrusions of the rotating die for manufacturing the screw of even lead angles are forming the lowest portion of the multi-pitch screw during the process, and the multi-pitch screw can be processed stably and continuously.

In the invention as set forth in claim 3, since the sectional area of even pitch protrusions and stair step protrusions is set nearly the same, and the load applied to the rotating die for manufacturing the screw of even lead angles and the rotating die for manufacturing the screw of uneven lead angles is uniform, and threads of the multi-pitch screw can be rolled stably.

In the invention as set forth in claim 4, the rotating die for manufacturing the screw of uneven lead angles is provided with stair step protrusions in the changeover positions from a taper part to a flat part. That is, in the changeover position from the taper part to the flat part for rolling an actual blank material, stair step protrusions are formed, and threads of the multi-pitch screw can be rolled stably. Further, since stair step protrusions are not formed, as far as possible, in the feed portion (protrusions in the flat part), it is effective to prevent flattening of threads of the multi-pitch screw rolled by stair step protrusions in the changeover positions by the stair step protrusions in the feed portion.

By forming the multi-pitch screw as in claim 6, an effective lead of the entire screw is an average of a moderate section of a lead angle and a steep section of the lead angle. As resistance to loosening of a screw, the frictional force against the opposite member in the moderate section of the lead angle by the force in the axial direction is dominant, and therefore while maintaining a large effective lead, a stronger loosening preventive action is obtained by the frictional force of the moderate section of the lead angel. On the other hand, the lowest position of a screw groove (a bottom of the thread and the thread) is in a general spiral screw shape and even lead angle, and when the leading end of the opposite side screw slides in the lowest position, smooth screw feed and screw tightening may be realized.

### BRIEF DESCRIPTION OF THE DRAWINGS

FIG. 1 is a side view of manufacturing apparatus of a multi-pitch screw of the invention.

FIG. 2 is a perspective exploded view of a rolling head 10.

FIG. 3 is a perspective view showing the principle of rolling method using the manufacturing apparatus of the multi-pitch screw of the invention.

FIG. 4A is a side view of rotating die 61 for manufacturing a screw of even lead angles, FIG. 4B is a sectional view, FIG. 4C is a magnified sectional view showing X1 part in FIG. 4B, and FIG. 4D is a side view of a circular columnar member 60 as a basic shape of a rotating die.

FIG. 5A is a side view of a rotating die 62 for manufacturing the screw of even lead angles, FIG. 5B is a sectional view, and FIG. 5C is a magnified sectional view showing X2 part in FIG. 5B.

FIG. 6A is a side view of a rotating die 63 for manufacturing the screw of uneven lead angles, FIG. 6B is a sectional view, FIG. 6C is a magnified sectional view showing X3 part in FIG. 6B, and FIG. 6D is a magnified view showing D part in FIG. 6A.

FIG. 7A is a diagram explaining difference in a basic shape between even pitch protrusions 610 (620, 630) and stair step uneven lead angle protrusions 632 (633). FIGS. 7B1, B2, B3, B4 are diagrams explaining changes in the relative position of even pitch protrusions 610 (620, 630) and stair step uneven lead angle protrusions 632 (633) due to rotation of rotating dies 61 and 62 for manufacturing the screw of even lead angles and the rotating die 63 for manufacturing the screw of uneven lead angles.

FIGS. 8A, 8B1, 8B2 are schematic diagrams of screw threads of the multi-pitch screw processed by the manufacturing method and manufacturing apparatus of the multi-pitch screw of the invention.

FIG. 9 is a side view of the rolling head used in a second embodiment of the invention.

FIG. 10A is a side view of the rotating die for manufacturing the screw of even lead angles used in the second embodiment of the invention, and FIG. 10B is a side view of the rotating die for manufacturing the screw of uneven lead angles.

### BEST MODE FOR CARRYING OUT THE INVENTION

### First Embodiment

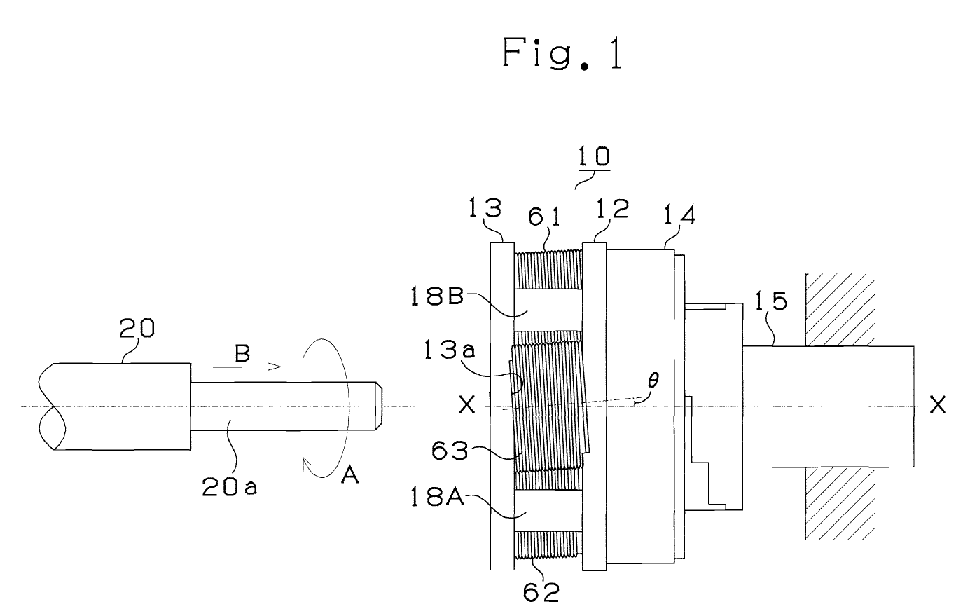

Referring first to FIG. 1 to FIG. 3, an outline of manufacturing method and manufacturing apparatus in a first embodiment of the invention is explained. A rolling head 10 is a conventional one using three rotating dies, and of the three rotating dies 61, 62, 63, the rotating dies 61 and 62 are for manufacturing the screw of even pitches conforming to the conventional structure, and the rotating die 63 has an own structure of the first embodiment. The rotating dies 61, 62 are for manufacturing the screw of even lead angles, and the rotating die 63 is for manufacturing the screw of uneven lead angles.

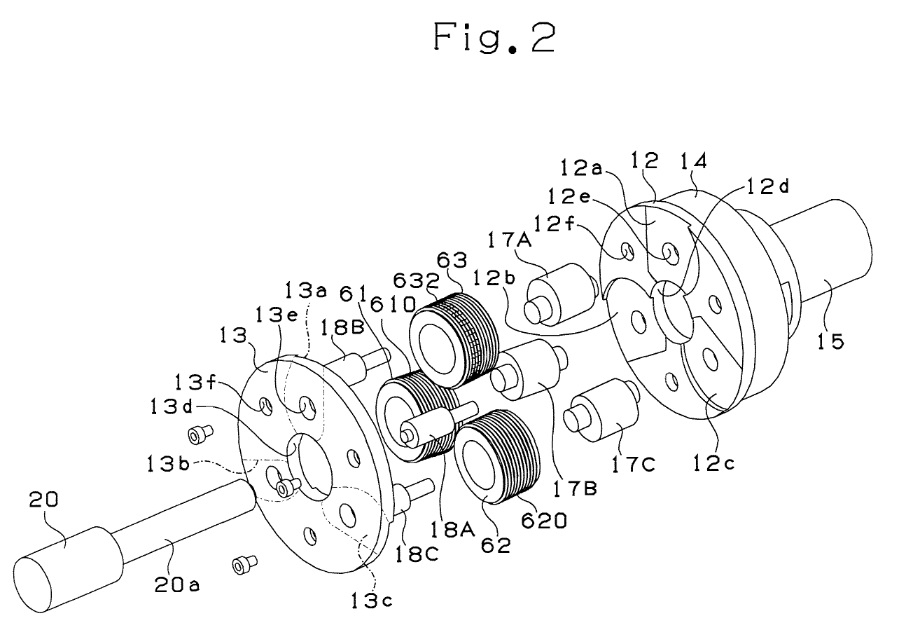

As shown in FIG. 2, the rolling head 10 has a circular base plate 12 having a through-hole 12d in the center, and a circular fixed plate 13 having a through-hole 13d in the center, and at one side of the base plate 12, a control mechanism 14 incorporating a clutch and a fixed shaft 15 are assembled. Between the other side of the base plate 12 and the fixed plate 13, three cylindrical dies are disposed, that is, the rotating dies 61, 62 for manufacturing the screw of even lead angles, and the rotating die 63 for manufacturing the screw of uneven lead angles, and they are installed rotatably at uniform intervals concentrically with the through-hole 12d and through-hole 13d by eccentric shafts 17A, 17B, 17C.

At the other side of the base plate 12 and the fixed plate 13, slopes 12a, 12b, 12c, and 13a, 13b, 13c are disposed correspondingly at the mounting positions of the eccentric shafts 17A, 17B, 17C penetrating through the rotating dies 61, 62 for manufacturing the screw of even lead angles, and the rotating die 63 for manufacturing the screw of uneven lead angles. The eccentric shafts 17A, 17B, 17C are held in through-hole 12e of the base plate 12 and through-hole 13e of the fixed plate 13. By combination of slopes 12a, 12b, 12c, and 13a, 13b, 13c and eccentric shafts 17A, 17B, 17C, the interval and a twist angle θ (see FIG. 1) of axial lines of rotating dies 61, 62, 63 and the central line X of the base plate 12 and the fixed plate 13 can be adjusted. In this rolling head 10, the slopes 12a, 12b, 12c, and 13a, 13b, 13c and eccentric shafts 17A, 17B, 17C are intended to form screws of various diameters, and according to the screw diameter, the distance between rotating dies 61, 62, 63 and the central line X and the twist angle θ can be adjusted. Therefore, they are not necessary when forming a multi-pitch screw of a single diameter.

Bolts 18A, 18B, 18C serve also as spacers for fixing the base plate 12 and the fixed plate 13 parallel to each other at a specified spacing. The bolts 18A, 18B, 18C are held in the through-hole 12f of the base plate 12 and the through-hole 13f of the fixed plate 13. A blank material 20 is processed from a round bar having plasticity such as iron, and a shaft portion 20a having screw threads formed by rolling is provided.

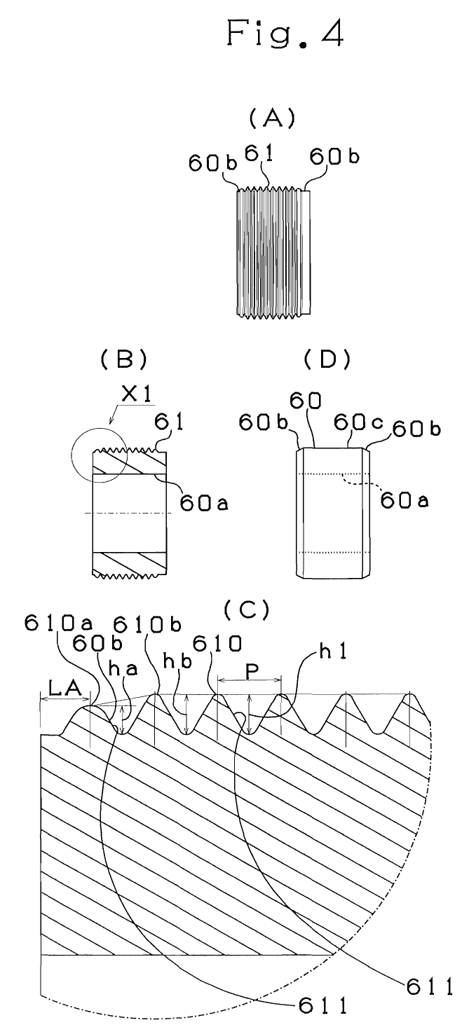

Referring next to FIG. 4 to FIG. 7, the shape of the rotating dies 61 and 62 for manufacturing the screw of even lead angles, and the rotating die 63 for manufacturing the screw of uneven lead angles is explained. FIG. 4D is a side view showing a circular columnar member 60 as a basic shape of the rotating die, and the rotating dies 61 and 62 for manufacturing the screw of even lead angles, and the rotating die 63 for manufacturing the screw of uneven lead angles are formed of the circular columnar member 60 of a high strength metal material of the same basic shape. A shaft hole 60a in which the eccentric shafts 17A, 17B, 17C are inserted is provided in the axial line portion of the circular columnar member 60, and a symmetrical taper portion 60b is formed on the outer circumference at both ends in the axial direction (an outer edge of the position 60c parallel to the axial center).

FIG. 4A is a side view of the rotating die 61 for manufacturing the screw of even lead angles, FIG. 4B is a sectional view, and FIG. 4C is a magnified sectional view showing X1 part in FIG. 4B. As mentioned above, the rotating die 61 for manufacturing the screw of even lead angles is a conventional rotating die for rolling a screw of even pitch by the rolling head. The rotating die 61 for manufacturing the screw of even lead angles has annular even pitch protrusions 610 of inverted V figure of the narrow width provided continuously in the inner circumference in the axial direction at the equal intervals (pitches P), and the depth h1 of U-shaped bottoms 611 formed among annular even pitch protrusions 610 adjacent at positions excluding the taper portion 60b (the same as the height of even pitch protrusions 610) is set constant. On the other hand, at taper portions 60b provided at both ends of the rotating die 61 for manufacturing the screw of even lead angles, the depths ha, hb of U-shaped bottoms 611 formed among adjacent annular even pitch protrusions (that is, the heights of a first protrusion 610a and a second protrusion 610b) are defined to be deeper sequentially. The first protrusion 610a starts at a specific position from one axial end side of the rotating die 61 for manufacturing the screw of even lead angles, that is, from the position of a distance LA as shown in FIG. 4C.

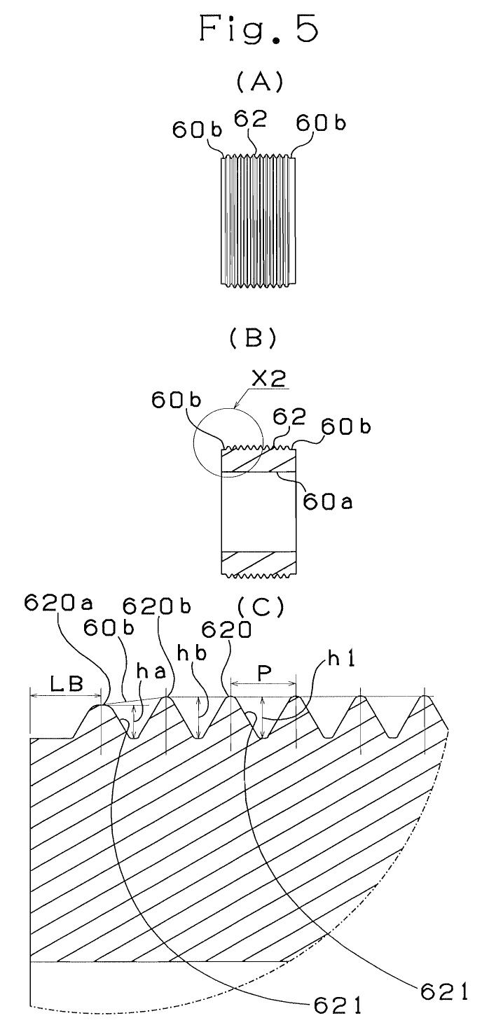

FIG. 5A is a side view of the rotating die 62 for manufacturing the screw of even lead angles, FIG. 5B is a sectional view, and FIG. 5C is a magnified sectional view showing X2 part in FIG. 5B. As mentioned above, the rotating die 62 for manufacturing the screw of even lead angles is, the same as the rotating die 61 for manufacturing the screw of even lead angles, a conventional rotating die for rolling a screw of even pitch by the rolling head. The rotating die 62 for manufacturing the screw of even lead angles has even pitch protrusions 620, the same as in the rotating die 61 for manufacturing the screw of even lead angles, provided continuously in the axial direction at equal intervals (pitches P). Same as in the rotating die 61 for manufacturing the screw of even lead angles, at the taper portions 60b provided at both ends of the rotating die 62 for manufacturing the screw of even lead angles, the depths ha, hb of U-shaped bottoms 621 formed among adjacent annular even pitch protrusions (that is, the heights of the first protrusion 620a and the second protrusion 620b) are defined to be deeper sequentially. The first protrusion 620a starts, as shown in FIG. 5C, at a position of a specific distance LB (LA<LB) from one axial end side of the rotating die 62. The difference of a distance LA and LB is determined by the ratio of a circumferential length of the rotating dies 61 and 62 for manufacturing the screw of even lead angles, and the rotating die 63 for manufacturing the screw of uneven lead angles, and the circumferential length of the shaft portion 20a forming screw threads of the blank material 20.

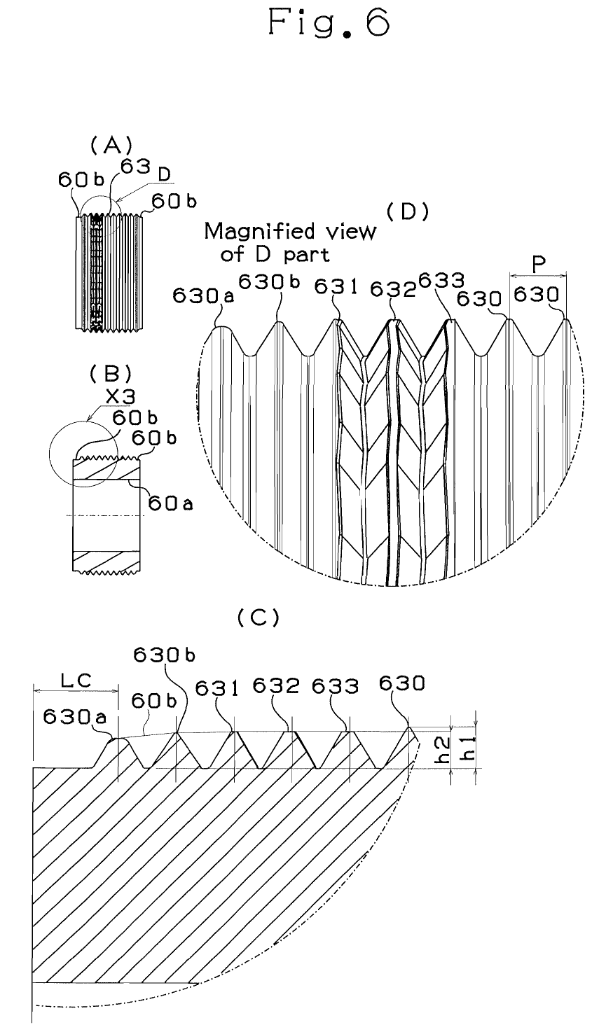

FIG. 6A is a side view of the rotating die 63 for manufacturing the screw of uneven lead angles, FIG. 6B is a sectional view, FIG. 6C is a magnified sectional view showing X3 part in FIG. 6B, and FIG. 6D is a magnified view showing D part in FIG. 6A. As mentioned above, the rotating die 63 for manufacturing the screw of uneven lead angles has an original structure of the embodiment, unlike the rotating dies 61 and 62 for manufacturing the screw of even lead angles. The rotating die 63 for manufacturing the screw of uneven lead angles has even pitch protrusions 630, the same as even pitch protrusions 610 and 620 in the rotating dies 61 and 62 for manufacturing the screw of even lead angles, provided continuously in the axial direction at equal intervals (pitches P), and on the circumference at the changeover portion of one taper portion 60b and a cylindrical portion, annular stair step uneven lead angle protrusions 631 to 633 changing continuously in waves are formed. The first protrusion 630a starts, as shown in FIG. 6C, at a position of a specific distance LC (having the relationship of LB<LC) from one axial end side of the rotating die 63 for manufacturing the screw of uneven lead angles. The difference of distance LB and LC is set the same as the difference of distance LA and LB.

Herein, the stair step uneven lead angle protrusions 631 to 633 are the same in the basic shape, and due to change in the outside diameter of the taper portion 60b, the leading end portion of the stair step uneven lead angle protrusions is changed sequentially, and the stair step uneven lead angle protrusions 632 and 633 show the basic shape.

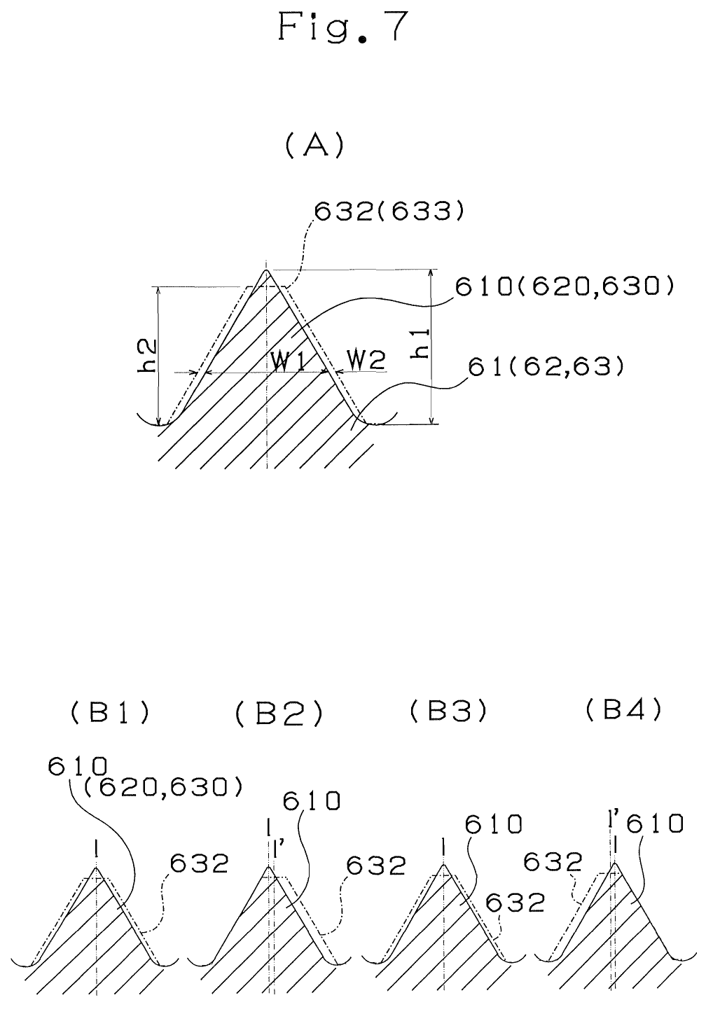

FIG. 7A is a magnified and emphasized sectional view matching the central lines for explaining difference in basic shape between even pitch protrusions 610 (620, 630) and stair step uneven lead angle protrusions 632 (633).

The height h1 of even pitch protrusions 610 (620, 630) is slightly higher than the height h2 of stair step uneven lead angle protrusions 632 (633), and the width W1 of even pitch protrusions 610 (620, 630) at an arbitrary position is set slightly narrower than the width W2 of stair step uneven lead angle protrusions 632 (633) at a corresponding position.

The difference of the height h1 and h2 and the width W1 and W2 of even pitch protrusions 610 (620, 630) and stair step uneven lead angle protrusions 632 (633) is determined so that the sectional area of the both may be almost equal.

FIGS. 7B1, B2, B3, B4 are overlapped views of even pitch protrusions 610 and stair step uneven lead angle protrusions 632, for explaining the difference in the basic shape of even pitch protrusions 610 (620, 630) and stair step uneven lead angle protrusions 632 (633). The central line 1′ of stair step uneven lead angle protrusions 632 coincides with the central line 1 of even pitch protrusions 610 side in FIG. 7B1, and the central line 1′ of stair step uneven lead angle protrusions 632 (633) is changed to the right direction in the diagram in FIG. 7B, then the central line 1′ of stair step uneven lead angle protrusions 632 (633) is changed in the left direction in the diagram in FIG. 7B3 (to be the same as in FIG. 7A), and further the central line 1′ is changed in the right direction in the diagram in FIG. 7B4. That is, the even pitch protrusions 610 do not change in the central position relating to the outer circumferential direction (the vertical direction to the axial line) of the rotating die 61 for manufacturing the screw of even lead angles, whereas the uneven lead angle protrusions 632 are designed to change the central position laterally relating to the outer circumferential direction. By settling the even pitch protrusions 610 (620, 630) among displacement width of uneven lead angle protrusions 631, 632, 633, as described below, the trace rolled by the uneven lead angle protrusions 631, 632, 633 is not flattened by the even pitch protrusions 610 (620, 630).

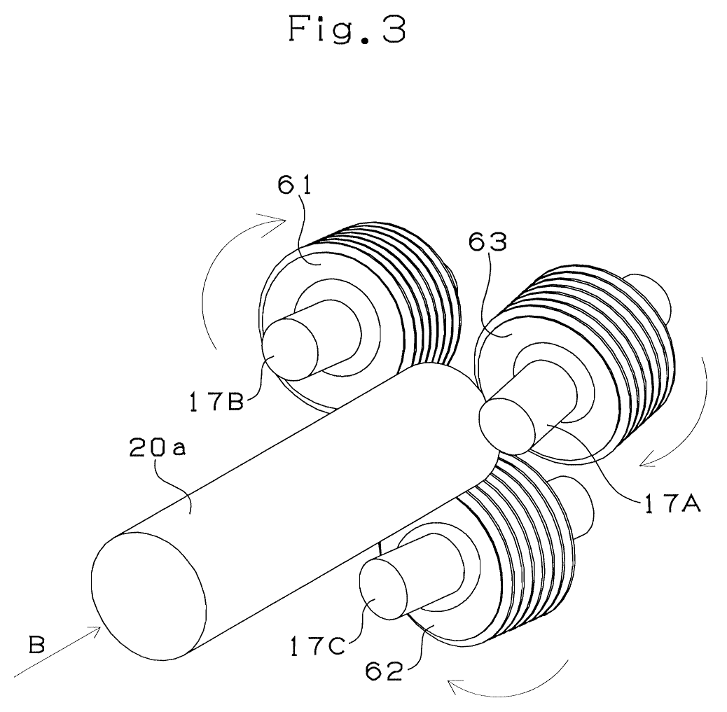

In succession, referring to FIG. 1 to FIG. 6, a method is explained below for processing multi-pitch screw threads in the shaft portion 20a of the blank material 20, by the rolling head 10, the rotating dies 61 and 62 for manufacturing the screw of even lead angles, and the rotating die 63 for manufacturing the screw of uneven lead angles, by using a lathe or the other machine tool. In the state shown in FIG. 1, the rolling head 10 is fixed by way of the fixed shaft 15, and on the line coinciding with the axial line of the rolling head 10, the blank material 20 is disposed rotatably, and movably back and forth in the axial direction. The blank material 20 is rotated in the direction of arrow A (a clockwise direction), and is also moved in the direction of arrow B, and is inserted in the through-hole 13d of the fixed plate 13 (see FIG. 2). As a result, as shown in FIG. 3, the shaft portion 20a of the blank material 20 contacts uniformly with each taper portion 60b of three dies, that is, the rotating dies 61 and 62 for manufacturing the screw of even lead angles, and the rotating die 63 for manufacturing the screw of uneven lead angles (see FIG. 4 to FIG. 6), and synchronously with rotation of the shaft portion 20a, the rotating dies 61 and 62 for manufacturing the screw of even lead angles, and the rotating die 63 for manufacturing the screw of uneven lead angles are put in rotation. Consequently, screw grooves of pitches determined by the adjusted twist angle θ (see FIG. 1) and even pitch protrusions 610 (620, 630) of the rotating dies 61 and 62 for manufacturing the screw of even lead angles, and the rotating die 63 for manufacturing the screw of uneven lead angles are rolled and formed gradually from the leading end of the shaft portion 20a.

Further, the shaft portion 20a of the blank material 20 is moved in the direction of arrow B along with rotation, and when the shaft portion 20a reaches the changeover position of each taper portion 60b of the rotating dies 61 and 62 for manufacturing the screw of even lead angles, and the rotating die 63 for manufacturing the screw of uneven lead angles and the cylindrical portion, by the protrusions 610 and 620 of rotating dies 61 and 62 for manufacturing the screw of even lead angles, the general (the even lead angle) spiral screw threads are rolled on the outer circumference of the shaft portion 20a, and the screw grooves are rolled in the multi-pitch profile by stair step uneven lead angle protrusions 631, 632, 633 of the rotating die 63 for manufacturing the screw of uneven lead angles.

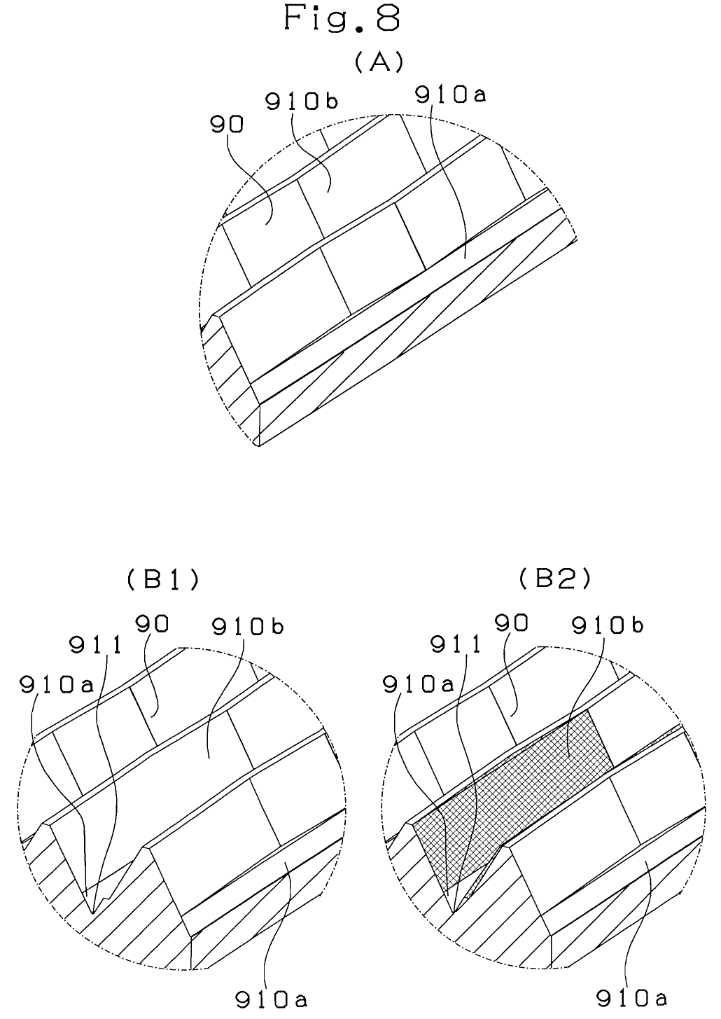

FIGS. 8A, 8B1, 8B2 are schematic flat views of multi-pitch screw grooves 90 rolled and processed on the outer circumference of the shaft portion 20a by the above processing. FIG. 8A and FIG. 8B1 show the same cut section end, but are different in the angle of showing the sectional position. FIG. 8B1 and FIG. 8B2 are the same diagrams, except that the moving portion by plastic processing is indicated by the cross hatching in FIG. 8B2. That is, the cross hatching area in FIG. 8B2 is processed plastically, and the shape shown in FIG. 8B1 is formed. A trace 910a is a trace of the general (the even lead angle) spiral screw threads formed by the even pitch protrusions 610 and 620 provided in the rotating dies 61 and 62 for manufacturing the screw of even lead angles. On the other hand, the trace 910b is a trace of stair step screw threads formed by stair step uneven lead angle protrusions 631, 632, 633 of the rotating die 63 for manufacturing the screw of uneven lead angles. In the first embodiment, the overlapped multi-pitch screw grooves 90 of both traces 910a and 910b are formed on the outer circumference of the shaft portion 20a of the blank material 20.

As the principle is shown in FIG. 8A, FIG. 8B1, the majority of both sides (side walls excluding the bottom area) of V-shaped screw grooves 90 shows the shape of the trace 910b, and forms the stair step or multi-pitch screw threads (a moderate section of a lead angle and a steep section of a lead angle alternately and mutually continuous in one revolution along a helical line). The lowest part (the bottom between thread and the thread) 911 of the screw groove 90 is a general spiral thread of even lead angle of the trace 910a.

By forming the multi-pitch screw in this manner, the effective lead of the entire screw becomes the average of the moderate section of the lead angle and the steep section of the lead angle. Resistance force to loosening of the screw is dominated by a frictional force against an opposite member in the moderate section of the lead angle by a force in the axial direction, and while holding a large effective lead, a stronger loosening resisting action is enforced by the frictional force in the moderate section of the lead angle. On the other hand, since the lowest part (the bottom between thread and the thread) 911 of the screw groove 90 is a general spiral thread of even lead angle, the leading end of opposite side screw slides in the lowest part, and smooth screw feed and screw tightening can be realized.

The lead angle of the moderate section of the lead angle can be set to zero (flat).

By thus forming, in the lead angle zero section, the force in axial direction is directly converted into frictional force, and partial force for turning the screw does not act at all, and the frictional force is much stronger in the lead angle zero section, and a stronger loosening preventive action takes effect.

The lead angle of the steep section of the lead angle can be can be set more acute than the self-lock angle. Self-lock is disclosed, for example, in Japanese Utility Model No. 2577786, which shows an automobile power seat for rotating the screw by a motor with a worm reduction gear, and feeding the nut member. When the motor is not driven, locking is realized by the self-lock of the feed screw itself or the self-lock of the worm reduction gear.

By thus forming, the screw loosening preventive action is assured in the moderate section of the lead angle, and the average effective lead can be increased. Therefore, the screw can be tightened or the engaged nut can be advanced by a slight rotation.

In this processing, since the sectional area is set nearly equal in the even pitch protrusions 610 (620, 630) and stair step uneven lead angle protrusions 632 (633), at the changeover position of the taper portion 60b of the rotating dies 61 and 62 for manufacturing the screw of even lead angles, and the rotating die 63 for manufacturing the screw of uneven lead angles, the plastic deformation amount of the outer circumference of the shaft portion 20a of the blank material 20, that is, the work amount is almost uniform. Accordingly, when rolling the multi-pitch screw groove 90 on the outer circumference of the shaft portion 20a of the blank material 20, biased load is not applied to the rotating dies 61 and 62 for manufacturing the screw of even lead angles, and the rotating die 63 for manufacturing the screw of uneven lead angles. When the leading end of the shaft portion 20a of the blank material 20 passes through the changeover position of the taper portion 60b of the rotating dies 61 and 62 for manufacturing the screw of even lead angles, and the rotating die 63 for manufacturing the screw of uneven lead angles, the same even pitch protrusions 610 (620, 630) are provided in the circular columnar portion of the rotating dies 61 and 62 for manufacturing the screw of even lead angles, and the rotating die 63 for manufacturing the screw of uneven lead angles, and in spite of the screw groove 90 in which the majority at both sides is the stair step or the multi-pitch screw, the leading end portion of even pitch protrusions 610 (620, 630) contacts and rotates on the lowest position 911 of the general spiral shape, and threads can be processed stably on the shaft portion 20a of the blank material 20. That is, as shown in FIGS. 7B1, B2, B3, B4, the trace 910a rolled by the uneven lead angle protrusions 631, 632, 633 will not be flattened out by the even pitch protrusions 610 (620, 630). Further, when the shaft portion 20a of the blank material 20 is fed, the even pitch protrusions 610 (620, 630) of the rotating dies 61 and 62 for manufacturing the screw of even lead angles, and rotating die 63 for manufacturing the screw of uneven lead angles hit against the upper side of the screw groove 90 only at the leading end, and act only on feed of the shaft portion 20a.

When the blank material 20 is fed in the direction of arrow B in FIG. 1, the leading end of the shaft portion 20a passes the through-hole 12d of the base plate 12, and reaches the clutch (not shown) of the control mechanism 14. As a result, by known clutch action, connection coupling of the fixed shaft 15 and the base plate 12 is cut off, and the base plate 12, the fixed plate 13, and the rotating dies 61 and 62 for manufacturing the screw of even lead angles, and the rotating die 63 for manufacturing the screw of uneven lead angles are rotated together with the shaft portion 20a of the blank material 20. Thus, the screw rolling process is terminated.

In this state, when the blank material 20 is rotated in the opposite direction of arrow A in FIG. 1, and is simultaneously moved in the opposite direction of arrow B, the processed shaft portion 20a of the blank material 20 is pulled out of the rolling head 10.

In the manufacturing method and manufacturing apparatus of the multi-pitch screw in the first embodiment, by the even pitch protrusions 610 and 620 of known rotating dies 61 and 62, the trace 910a of the general spiral screw is formed, and it is overlapped with the trace 910b of the stair step screw formed by the uneven lead angle protrusions 631, 632, 633 of the rotating die 63 for manufacturing the screw of uneven lead angles, and the multi-pitch screw groove 90 can be rolled easily and efficiently. Only one rotating die 63 for manufacturing the screw of uneven lead angles is used, and screw threads are not flattened out by stair step protrusions of the plurality of rotating dies for manufacturing the screw of uneven lead angles. Further, the rotating die 63 for manufacturing the screw of uneven lead angles is hard to manufacture and expensive, but since only one is used in three rotating dies in the first embodiment, and stair step protrusions 331, 332, 333 are formed only in part, and the multi-pitch screw can be manufactured at low cost. In the rotating die 61 for manufacturing the screw of even lead angles, only part (the changeover position of the taper portion 60b) is formed in stair step protrusions 331, 332, 333, and the remaining protrusions are even pitch protrusions 630, and the multi-pitch screw threads (the trace 910b) rolled by partial stair step protrusions 331, 332, 333 can be prevented from being flattened out by the feed portion (the remaining even pitch protrusions 630).

Moreover, the even pitch protrusions 610, 620 of the rotating dies 61 and 62 for manufacturing the screw of even lead angles are set higher and narrower than the stair step protrusions 631, 632, 633 of the rotating die 63 for manufacturing the screw of uneven lead angles. Accordingly, the leading ends of even pitch protrusions 610 and 620 of rotating dies 61 and 62 for manufacturing the screw of even lead angles form the lowest portion 911 of the multi-pitch screw in the manufacturing process, so that the multi-pitch screw can be processed stably and continuously.

The rotating die 63 for manufacturing the screw of uneven lead angles has the stair step protrusions 631, 632, 633 formed in the changeover position from the taper portion 60b to the flat portion. That is, since the stair step protrusions 631, 632, 633 are formed in the changeover position from the taper portion 60b to the flat portion for rolling by actually contacting with the blank material 20, the multi-pitch screw threads can be rolled stably. Further, since stair step protrusions are not formed in the feed portion (protrusions in flat portion) as far as possible, the multi-pitch screw threads rolled by the stair step protrusions in the changeover position are prevented from being flattened out by the uneven lead angle protrusions in the feed portion.

### Second Embodiment

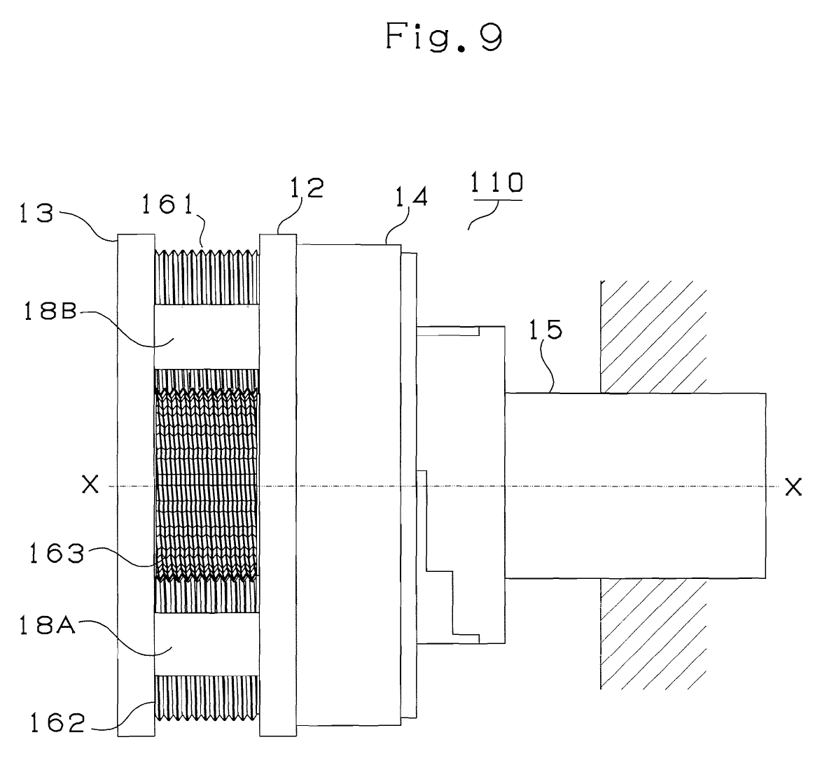

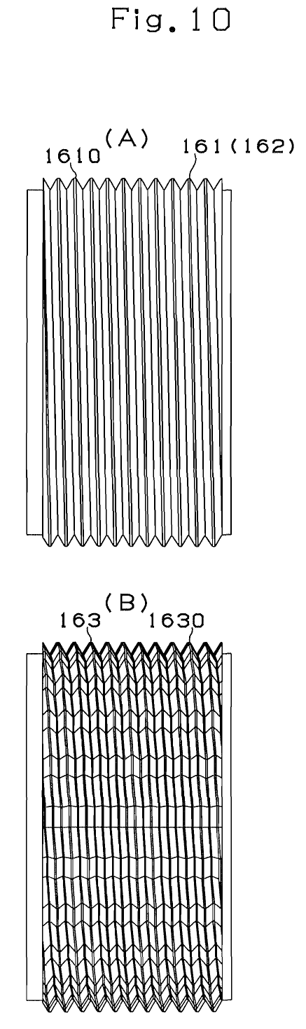

A second embodiment is described by referring to FIG. 9 and FIG. 10. FIG. 9 shows a rolling head 110 used in the second embodiment, FIG. 10A shows a rotating die 161 (162) for manufacturing the screw of even lead angles used in the rolling head 110, and FIG. 10B shows a rotating die 163 for manufacturing the screw of uneven lead angles used in the rolling head 110. In the first embodiment, the rotating dies 61, 62, 63 have annular protrusions 610, 620, 630, 632 on the outer circumference. In the second embodiment, by contrast, the rotating die 161 for manufacturing the screw of even lead angles and the rotating die 163 for manufacturing the screw of uneven lead angles have spirally linked protrusions 1610 and 1630 on the outer circumference. Further, in the first embodiment, uneven lead angle protrusions 631, 632, 633 are formed only in part of the rotating die 63 for manufacturing the screw of uneven lead angles, but in the second embodiment, uneven lead angle protrusions 1630 are provided on the entire outer circumference of the rotating die 163 for manufacturing the screw of uneven lead angles. The basic shape of rotating dies 161 and 162 is the same as in the first embodiment shown in FIG. 4D, that is, a circular columnar member 60 of the high strength metal material. Also in the first embodiment, the rotating dies 61, 62, 63 are disposed at a twist angle θ, but in the second embodiment, the rotating dies 161, 162, 163 are disposed horizontally to the axial line X. That is, eccentric axes 17A, 17B, 17C are ordinary axes, and the rolling head 110 composed of the base plate 12 and the fixed plate 13 not having slopes 12a, 12b, 12c, and 13a, 13b, 13c is used. In this constitution of second embodiment, the multi-pitch screw can be manufactured the same as in the first embodiment.

### INDUSTRIAL APPLICABILITY

Three rotating dies are used in the foregoing embodiments, but the manufacturing method and manufacturing apparatus of the multi-pitch screw of the invention can be realized by two or more rotating dies. For example, when two rotating dies are used, a rotating die for manufacturing the screw of even lead angles and a rotating die for manufacturing the screw of uneven lead angles are used, or when four rotating dies are used, three rotating die for manufacturing the screw of even lead angles and a rotating die for manufacturing the screw of uneven lead angles are used.

Further, in the first embodiment, uneven lead angle protrusions 631, 632, 633 are formed only in the part of the rotating die 63 for manufacturing the screw of uneven lead angles, but uneven lead angle protrusions may be formed on the entire outer circumference.

1. A manufacturing method of a multi-pitch screw for rolling and processing spiral multi-pitch screw threads on an outer circumference of a shaft-shaped blank material, by a plurality of rotating dies having protrusions of inverted V figure linked annularly or spirally on the outer circumference,
wherein other rotating dies except for one of the plurality of rotating dies are rotating dies for manufacturing a screw of even lead angles, having protrusions provided at even pitches,
the one rotating die is a die for manufacturing a screw of uneven lead angles having protrusions provided in part as stair steps changing in waves in the groove direction, and
multi-pitch screw threads are rolled by the plurality of rotating dies, overlapped between the trace of even lead angle threads formed by protrusions of even pitches on the outer circumference of the shaft-shaped blank material, and the trace of stair step screw threads formed by threads formed by protrusions of even pitches on the outer circumference of the shaft-shaped blank material.

2. A manufacturing method of a multi-pitch screw for rolling and processing spiral multi-pitch screw threads on an outer circumference of a shaft-shaped blank material, by a plurality of rotating dies having annular protrusions of inverted V figure linked on the outer circumference,
wherein other rotating dies except for one of the plurality of rotating dies are rotating dies for manufacturing a screw of even lead angles, having protrusions provided at even pitches,
the one rotating die is a die for manufacturing a screw of uneven lead angles having protrusions provided in part as stair steps changing in waves in the groove direction, wider slightly in width and slightly lower in height as compared with the protrusions of even pitch, and provided at even pitch in a remaining portion except for the stair step protrusions,
multi-pitch screw threads are rolled by the plurality of rotating dies, overlapped between the trace of even lead angle threads formed by protrusions of even pitches on the outer circumference of the shaft-shaped blank material, and the trace of stair step screw threads formed by threads formed by protrusions of even pitches on the outer circumference of the shaft-shaped blank material.

3. The manufacturing method of the multi-pitch screw of claim 1, wherein even pitch protrusions and stair step protrusions are formed nearly in the same sectional area.

4. The manufacturing method of the multi-pitch screw of claim 1, wherein the rotating die for manufacturing the screw of uneven lead angles has a taper portion at both ends parallel to an axial center, and stair step protrusions are formed in the changeover position from the taper portion to the flat portion.

5. A manufacturing apparatus of a multi-pitch screw using the manufacturing method of any one of claim 1.

6. A multi-pitch screw,
wherein the bottom portion between threads is an even lead angle, and
the side wall of screw threads are formed alternately and continuously between a moderate section and a steep section of the lead angle alternating in one revolution of the helical line.
